(19) United States
(12) Patent Application Publication
(10) Pub. No.: US 2022/0292761 A1
(43) Pub. Date: Sep. 15, 2022

(54) METHOD AND APPARATUS TO EXTRACT POWERLINES FROM LIDAR POINT CLOUD DATA

(71) Applicant: Oregon State University, Corvallis, OR (US)

(72) Inventors: Jaehoon Jung, Corvallis, OR (US); Michael J. Olsen, Corvallis, OR (US); Erzhuo Che, Corvallis, OR (US)

(73) Assignee: Oregon State University, Corvallis, OR (US)

(21) Appl. No.: 17/653,720

(22) Filed: Mar. 7, 2022

Related U.S. Application Data
(60) Provisional application No. 63/159,321, filed on Mar. 10, 2021.

(51) Int. Cl. G06T 15/08; G06T 7/187; G06T 7/11

(52) U.S. Cl. CPC G06T 15/08; G06T 7/187; G06T 7/11

(57) ABSTRACT

An efficient and robust approach for powerline point extraction and refinement is described. In the candidate powerline point extraction step, a voxel-based subsampling structure temporarily substitutes the original scan points with regularly spaced subsampled points that still preserve key details present within the point cloud but significantly reduce the dataset size. After removing the ground surface and adjacent objects, candidate powerline points are efficiently extracted through a hierarchical, feature-based filtering process. In the refinement step, the link between the subsampled candidate powerline points and original scan point cloud enable the original points to be segmented and grouped into clusters. By fitting mathematical models, an individual powerline is re-clustered and used to reconstruct the broken sections in the powerlines.

### CLAIM OF PRIORITY

This application claims priority to United States Non-Provisional patent application No. 63/159,321 titled “METHOD AND APPARATUS TO EXTRACT POWERLINES FROM LIDAR POINT CLOUD DATA,” filed Mar. 10, 2021, which is incorporated by reference in its entirety.

### STATEMENT OF GOVERNMENT SUPPORT

This invention was made with government support awarded by the National Science Foundation Award No. CMMI1351487. The Government has certain rights in the invention.

### BACKGROUND

Powerlines are a vital component of the infrastructure to distribute electricity from production sites to users. Considering that many powerlines have been in place long past their original intended design life and continually degrade from environmental factors, such as storms and flooding, it is critical to monitor the status of powerlines on a regular basis to ensure safe and reliable transmission.

### BRIEF DESCRIPTION OF THE DRAWINGS

FIG. 1 illustrates a flowchart of a method to extract powerlines from Lidar point cloud data, in accordance with some embodiments.

FIGS. 2A-B illustrate voxel-based subsampling with original scan points (5,456,853 points) and subsampled points (36,455 points) generated with a spacing interval of 0.5 m, respectively, in accordance with some embodiments.

FIG. 3 illustrates ground filtered subsampled points, in accordance with some embodiments.

FIGS. 4A-D illustrate refinement of ground points over segmented ground points in the powerlines, rasterization of ground points, detection of the largest segment, and refined ground points, respectively, in accordance with some embodiments.

FIG. 5 illustrates conceptual illustration of the height constraint.

FIG. 6A-D illustrate height filtering using a 3D morphological process with subsampled points for ground segment, ground segment enlarged with zₘᵢₙ, ground segment within the height constraint, respectively, in accordance with some embodiments.

FIGS. 7A-B illustrate feature-based filtering using subsampled points with a larger spacing interval (s1) of 0.5 m, and with a smaller spacing interval (s2) of 0.1 m, respectively, in accordance with some embodiments.

FIGS. 8A-C illustrate image-based filtering in a binary image with ellipse fitting for each segment, and powerlines before filtering small pixel groups, and powerlines after filtering small pixel groups, respectively, in accordance with some embodiments.

FIG. 9 illustrates initial clustering results of candidate powerline points where each individual cluster is presented by a unique color, in accordance with some embodiments.

FIGS. 10A-B illustrate combined clusters in the horizontal plane, and combined clusters in the vertical plane, in accordance with some embodiments.

FIG. 11 illustrates an example of clusters that are on the same straight line in the horizontal plane, but suspected in different spans, in accordance with some embodiments.

FIG. 12 illustrates identified powerlines with some broken sections, where each individual powerline is represented with a different color, in accordance with some embodiments.

FIG. 13 illustrates a reconstruction of powerlines in the vertical plane, in accordance with some embodiments.

FIG. 14 illustrates fully reconstructed powerlines, where each individual powerline is represented with a different color, in accordance with some embodiments.

FIGS. 15A-E illustrate point cloud data acquired using MLS in Mulino in 2016, Mulino in 2018, Salem, Philomath, and using TLS in Mulino in 2019, respectively.

FIGS. 16A-B illustrate examples of powerlines including other objects of vibration dampers, or multiple lines, respectively, in accordance with some embodiments.

FIGS. 17A-D illustrate examples of extracted powerlines in the datasets of b-1, c-3, d-4, and e-4, respectively, in accordance with some embodiments.

FIGS. 18A-B illustrate examples of false positives in the datasets with powerlines d-5 and e-4, respectively, according to some embodiments.

FIGS. 18C-D illustrate without of false positives without powerlines c-6 and e-6, in accordance with some embodiments.

FIG. 19 illustrates a plot showing change in s1 with respect to the density of ground truth for MLS data, in accordance with some embodiments.

FIGS. 20A-B illustrate comparison of powerlines extracted from a-6 database using parameters optimized or all the datasets, and for the low-density datasets only, in accordance with some embodiments.

FIGS. 21A-B illustrate comparison of powerlines extracted from b-6 database using Zₘᵢₙ of 4 m, and 0 m, respectively.

FIG. 22 illustrates a computer system with machine-readable media having machine executable instructions to perform a method extract powerlines from Lidar point cloud data, in accordance with some embodiments.

FIG. 23 illustrates a flowchart to extract powerlines from lidar data, in accordance with some embodiments.

### DETAILED DESCRIPTION

Powerlines are a vital component of the infrastructure to distribute electricity from production sites to users. Considering that many powerlines have been in place long past their original intended design life and continually degrade from environmental factors, such as storms and flooding, it is critical to monitor the status of powerlines on a regular basis to ensure safe and reliable transmission. However, it is a challenging task to periodically monitor the vast network of powerlines that stretch across the globe, rendering traditional field monitoring techniques time consuming and costly. Alternatively, there have been many efforts to utilize remote sensing techniques, such as camera and laser scan imaging systems; however, compared with a camera sensor, laser scanning system, an active sensor is not susceptible to lighting conditions and provides dense 3D data in the information-rich form of a point cloud that can reconstruct complex 3D details of the object surface and scene. As a result, laser scanning technique has become increasingly popular for powerline monitoring. Broadly speaking, laser scanning data can be categorized into airborne or terrestrial-based measurements. Each acquisition platform has its own capabilities and limitations in powerline monitoring. Airborne systems such as airborne laser scanning (ALS) or unmanned aircraft systems laser scanning (ULS) are equipped with a laser scanning sensor and other supplemental sensors such as a global navigation satellite system (GNSS) and inertial navigation system (INS) for direct georeferencing.

ALS is advantageous for collecting scans with relatively uniform point density across a large area where personnel or vehicles are difficult to access. However, given the scanning geometry from above, ALS often only acquires partial scans on lower layers of multilayer powerlines given that the upper powerlines mask the lower ones. Terrestrial or ground based measurements can be acquired by either a terrestrial laser scanning (TLS) or mobile laser scanning (MLS) system. While TLS is set up on a tripod by users with survey targets for georeferencing, MLS systems ordinarily operate on a vehicle equipped with GNSS and IMU for direct georeferencing. Compared to ALS, they can provide more dense and accurate scan data, but are limited to areas around the scanner locations or trajectory (typically within 100 m). The point density is also highly variable with heavy oversampling close to the scanner but sparser data with distance. These terrestrial-based systems also have a better view of multi-layer powerlines. This study focuses on the extraction of powerlines using the higher, but variable, resolution point clouds acquired by MLS or TLS.

There are several challenges when extracting powerlines from point clouds. The immense data volume of point clouds often results in bottlenecks in data processing. Given their high levels of detail, point clouds also include various noises and other objects, rendering reliable extraction of powerlines difficult. To address this problem, many existing approaches, which are summarized in Section 2, tend to rely on supplemental data (e.g., vehicle trajectory, return number, intensity, or pre-classified data), limiting their applicability. Further, many approaches have been tested on a limited number of datasets without thorough evaluations, thereby their robustness is not fully evaluated. To overcome these challenges, the primary objective of this paper is to develop a versatile, efficient, and robust method for automatic powerline extraction that can reliably: (1) Extract powerlines from point clouds acquired in a variety of conditions, such as urban, rural, and forest locales, (2) Apply to both TLS or MLS without requiring supplemental data, (3) Scale to efficiently process large (hundreds of millions of points) datasets using a hierarchical, voxel-based subsampling structure, and (4) Provide consistent results irrespective of the characteristics of the input dataset with a single set of optimized parameters with minimal sensitivity to said parameters.

Compared with camera imaging systems, a laser scanning system is not susceptible to lighting conditions and provides dense 3D data in the information-rich form of a “point cloud” that can reconstruct complex 3D details of the object surface and scene. As a result, laser scanning techniques have become increasingly popular for powerline monitoring.

Broadly speaking, laser scanning data can be acquired by either airborne laser scanning (ALS), terrestrial laser scanning (TLS), or mobile laser scanning (MLS) systems. All these laser scanning systems currently rely on a technology known as Lidar, which stands for Light Detection and Ranging, a remote sensing method that uses light in the form of a pulsed laser to acquire imaging data. In general, to automate a powerline monitoring task using laser scanning data, one must acquire images and then extract the powerlines from the imaging data: we call this process “powerline extraction.”

Although there have been many advances in powerline extraction from point clouds, existing approaches suffer in terms of efficiency—struggling with increased computational complexity as data size increases. Data complexity is a real concern because recent Lidar scanning systems enable the collection of a substantial number of points (millions per second). (The information density of point cloud data is increasing.)

Refer to Table 1 herein for a comparison of powerline extraction methods used in the state of the art. The efficiency in Table 1 is calculated by dividing the number of points by the time consumption presented in the literature. Note that the efficiency does not account for loading the data. When exact values are not available, the performance metrics are approximated and marked with “≈”. The efficiency is not available for some methods (marked N/A) due to the lack of reported time consumption in publicly available reports. Even when this information is reported, the efficiency is increasingly unsatisfactory (becoming unusable after a few thousand points/sec in data density).

TABLE 1

| | | | | Efficiency | # of datasets | | |
|---|---|---|---|---|---|---|---|
| Scanning | | Precision | Recall | (million | (million | | Supplemental |
| system | Methods | (%) | (%) | points/sec) | points) | Study site | data |
| ALS | Yang and | 96.78 | 98.67 | 0.003 | 4 | Mountain | Training |
| | Kang, 2018 | | | | (2.4-7.04) | | Data |
| | Wang et al. | 98.00 | 98.00 | 0.003-0.005 | 2 | Urban | Training |
| | 2017 | | | | (0.10-0.27) | | Data |
| | Guo et al. | 89.80 | N/A | N/A | 1 | Mountain | Training |
| | 2016 | | | | (N/A) | | data |
| | Awrangjeb | 99.95 | 88.18 | N/A | 1 | Mountain | Classified |
| | et al. 2018 | | | | (3.53) | | pylon |
| | Ortega et al. | 99.44 | 99.58 | 0.073 | 48 | Rural, | Intensity, |
| | 2019 | | | | (1.5~2.5) | mountain, | return |
| | | | | | | forest | number |
| MLS | Cheng et al. | 99.10 | 93.220 | 0.31 | 1 | Urban | None needed |
| | 2014 | | | | (≈30.00) | | |
| | da Silva et al. | 92.54-98.17 | 99.220-100.00 | N/A | 2 | Rural | Semi- |
| | 2015 | | | | (N/A) | | automatic |
| | Guan et al. | 99.00 | 92.00 | N/A | 2 | Urban | None needed |
| | 2016 | | | | (7.80-8.40) | | |
| | Zhang et al. | N/A | N/A | N/A | 1 | Railroad | Trajectory |
| | 2016 | | | | (N/A) | | |
| | Yadav and | 98.84 | 220.84 | N/A | 3 | Urban, | None needed |
| | Chousalkar, | | | | (4.27-9.10) | suburban, | |
| | 2017 | | | | | rural | |
| | Xu and Wang, | ≈98.00 | ≈95.00 | N/A | 2 | N/A | Trajectory |
| | 2019 | | | | (6.12-272.61) | | |
| | Lehtomaki | 93.60 | 93.30 | N/A | N/A | Arable | None needed |
| | et al. 2019 | | | | (6-15) | land, | |
| | | | | | | forest | |
| | Sanchez- | 93.28-96.42 | 96.36-93.55 | N/A | 3 | Tunnel | Trajectory, |
| | Rodriguez | | | | (45.79-332.65) | | return |
| | et al. 2019 | | | | | | number |
| TLS | Husain and | 98.54 | 96.89 | 0.10 | 1 | Urban | None needed |
| | Vaishya, 2019 | | | | (42.07) | | |
| ALS + MLS | Wang et al. | 98.70 | 88.70 | 0.005 | 5 | Urban, | Training |
| | 2018 | | | | (0.27-15.70) | suburban, | data |
| | | | | | | forest | |
| TLS + MLS | Various | 92.42-96.76 | 82.58-97.65 | 0.84-1.68 | 30 | Urban, | None needed |
| | embodiments | | | | (9.11-63.58) | rural, | |
| | | | | | | forest | |

Beyond efficiency, note that many approaches rely on supplemental data (for example, intensity, return number, vehicle trajectory, or training data) thereby limiting the versatility of the approaches. Further still, as shown in Table 1 under the first column, many of the approaches in the state of the art have only been tested on a specific region (either urban, rural, or forest) or with a specific scanning system (e.g., ALS, TLS, or MLS). Outside of these conditions, it is uncertain whether they will scale to work effectively with datasets acquired in diverse conditions.

Some embodiments address powerline extraction from Lidar data. Following initial conditions (input or data) are used. (1) Powerlines are located above the ground and distributed linearly with a sagging posture between neighboring utility poles or towers, and (2) input data is an unorganized point cloud acquired by either MLS or TLS. In some examples, any supplemental data, such as vehicle trajectory or pre-classified data, may not be used for extraction at this point.

Some embodiments describe an efficient and robust approach for powerline point extraction and refinement. In a candidate powerline point extraction step, a voxel-based subsampling structure temporarily substitutes the original scan points with regularly spaced subsampled points that still preserve key details present within the point cloud but significantly reduce the dataset size. After removing the ground surface and adjacent objects, candidate powerline points are efficiently extracted through a hierarchical, feature-based filtering process. In the refinement step, the link between the subsampled candidate powerline points and original scan point cloud enable the original points to be segmented and grouped into clusters. By fitting mathematical models, an individual powerline is re-clustered and used to reconstruct the broken sections in the powerlines.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices.

Here, the term “digital signal” is a physical signal that is a representation of a sequence of discrete values (a quantified discrete-time signal), for example of an arbitrary bit stream, or of a digitized (sampled and analog-to-digital converted) analog signal.

The term “coupled” means a direct or indirect connection, such as a direct electrical, mechanical, or magnetic connection between the things that are connected or an indirect connection, through one or more passive or active intermediary devices.

The term “adjacent” here generally refers to a position of a thing being next to (e.g., immediately next to or close to with one or more things between them) or adjoining another thing (e.g., abutting it).

The term “circuit” or “module” may refer to one or more passive and/or active components that are arranged to cooperate with one another to provide a desired function.

The term “signal” may refer to at least one current signal, voltage signal, power signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The terms “left,” “right,” “front,” “back,” “top,” “bottom,” “over,” “under,” and the like in the description and in the claims, if any, are used for descriptive purposes and not necessarily for describing permanent relative positions.

It is pointed out that those elements of the figures having the same reference numbers (or names) as the elements of any other figure can operate or function in any manner like that described but are not limited to such.

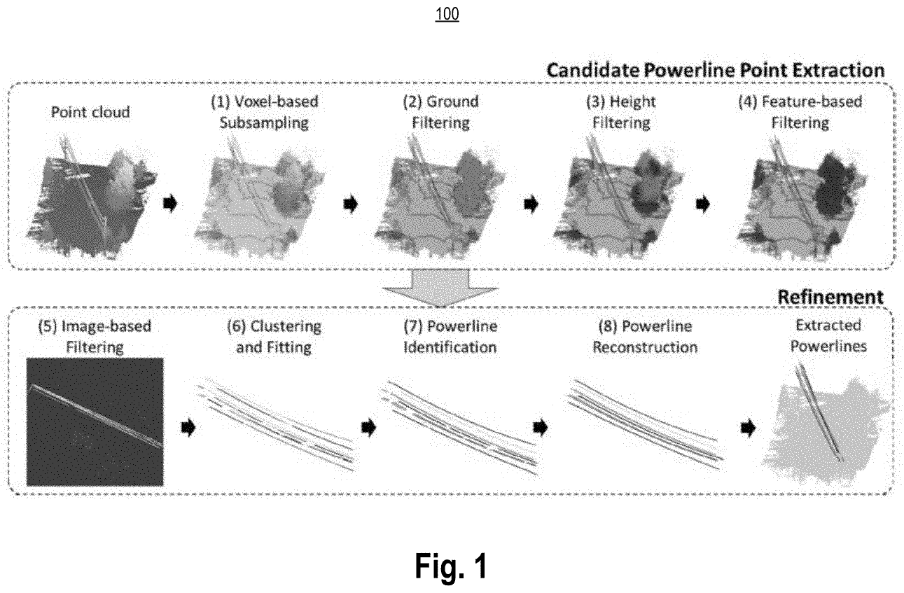

FIG. 1 illustrates flowchart 100 of a method to extract powerlines from Lidar point cloud data, in accordance with some embodiments. While various operations are shown in a particular order. The order can be modified. For example, some operations can be performed in parallel with other operations. The various operations can be performed by hardware, software, or a combination of them.

The proposed approach extracts overhead powerlines that are located above the ground and distributed linearly with a sagging posture between two neighboring utility poles or towers. In some embodiments, the input is solely an unorganized point cloud acquired by either MLS or TLS; any supplemental data, such as vehicle trajectory or pre-classified data, are not necessary for the extraction. The outputs are individually segmented powerlines. Note that the connectivity or transition between the powerlines from different spans is not considered. Broadly, the proposed approach can be divided into two principal steps: candidate powerline point extraction and refinement. Candidate powerline point extraction can be further divided into four sub-procedures: (1) voxel-based subsampling to reduce the data size; (2) ground filtering to identify the ground elevation; (3) height filtering to remove unwanted objects within a certain height range above the ground; and (4) feature-based filtering to remove unwanted objects near the powerlines. These four steps use the subsampled points, which play a key role to improve efficiency. Subsequently, the original scan points are segmented according to the 3D locations of the subsampled candidate powerline points and fed into the refinement step, which includes: (5) image-based filtering to filter small noise objects around the powerlines; (6) clustering and fitting with mathematical models; (7) powerline identification to detect individual powerlines; and finally (8) powerline reconstruction to recover broken sections. The output is a 3D point cloud with unique labels for each powerline. The consecutive steps of the proposed approach are schematized in FIG. 1. Note that, except for parameter selection, the proposed approach is automatic and requires no manual intervention.

Voxel-based subsampling: Powerline extraction requires a series of steps to remove various types of unwanted objects, such as buildings, trees, utility poles, vehicles, pedestrians, and ground. These steps can be very time-consuming because of the immense size of point clouds. To overcome this challenge, subsampled points are generated with reference to the geometric coordinates of the original scan points as follows:

$$x y {z}_{s u b} = ( floor ( \frac{x y z - x y {z}_{min}}{{S}_{1}} ) + 0.5 ) \times {S}_{1} + x y {z}_{min} \qquad ( 1 )$$

where xyz is the geometric coordinates (x, y, z) of original scan points, xyzₘᵢₙ is the minimum geometric coordinates of the original scan points, s1 is the spacing interval between the subsampled points, and xyz_{sub} is the subsampled points. Floor(t) returns a value rounded to the nearest integer below the value of t. The idea of the voxel-based subsampling is to split the original scan points into regularly-spaced 3D grid cells and use the center coordinates of the occupied grid cells (i.e., containing at least one scan point). Voxel-based subsampling is an intelligent subsampling to reduce the data size. The idea of the intelligent subsampling is to split the original scan points into regularly-spaced 3D grid cells and use the center coordinates of the occupied grid cells (i.e., containing at least one scan point). The intelligent subsampling can significantly reduce the data volume of original scan points by balancing the point density within dense and sparse areas.

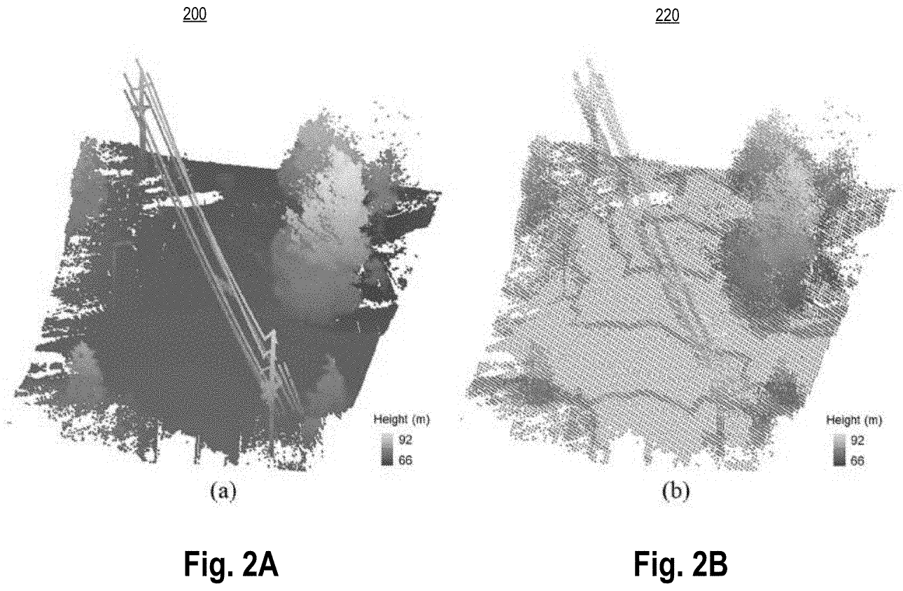

FIGS. 2A-B illustrates voxel-based subsampling with original scan points 200 (5,456,853 points) and subsampled points (36,455 points) 220 generated with a spacing interval of 0.5 m, respectively, in accordance with some embodiments. FIGS. 2A-B compares the original scan points with the subsampled points. The voxel-based subsampling can significantly reduce the data volume of original scan points by balancing the point density within dense and sparse areas. The selection of an appropriate spacing interval (s1) is critical for the effective use of the voxel-based subsampling for powerline extraction. It should be large enough to reduce the data volume to improve computational efficiency; however, too large of a value could lead to the loss of important details. Some embodiments discuss the selection of s1 in more detail. Ultimately, this parameter is controlled by the density at which the data were collected.

Referring to FIG. 1, the next operation is ground filtering to identify the ground elevation.

Ground filtering: Because various embodiments focus on extracting the overhead powerlines suspended on utility poles, ground filtering is an important prerequisite to reduce the unwanted ground objects (e.g., road surface, sidewalk, grass, etc.). Some embodiments adopt the simple morphological filter (SMRF) ground filtering, which applies progressive morphological filtering to separate the ground from other objects. Many other alternative ground filtering methods—as long as their performance is acceptable—could be used in the proposed framework. It is worth noting the ground filtering is performed on the subsampled points, which enables the processing time to be greatly reduced.

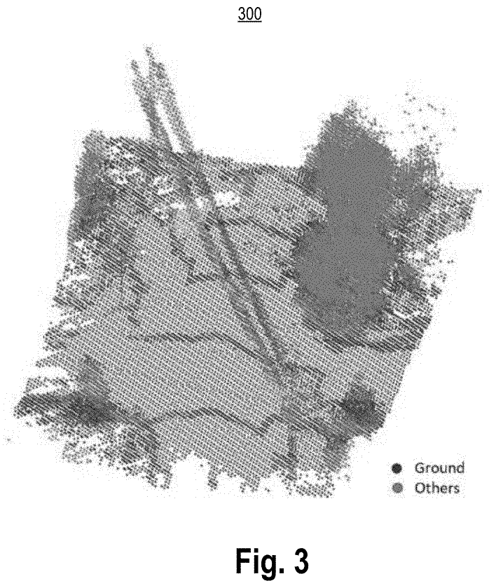

FIG. 3 illustrates example 300 of the segmented ground using subsampled points, in accordance with some embodiments. The processing time of the ground filtering can be greatly reduced by applying it to the subsampled points generated in the voxel-based subsampling operation. Note that ground filtering often over-segments the ground from non-ground objects in the areas distant from the scanner. To handle this problem, some embodiments rasterize the ground-filtered subsampled points in the x-y plane to perform a connected component analysis that identifies isolated pixel groups. Subsequently, some embodiments remove small groups that do not connect with the largest one. Some embodiments segment the ground points according to their 2D locations as projected on the largest group, such that the over-segmentation can be avoided.

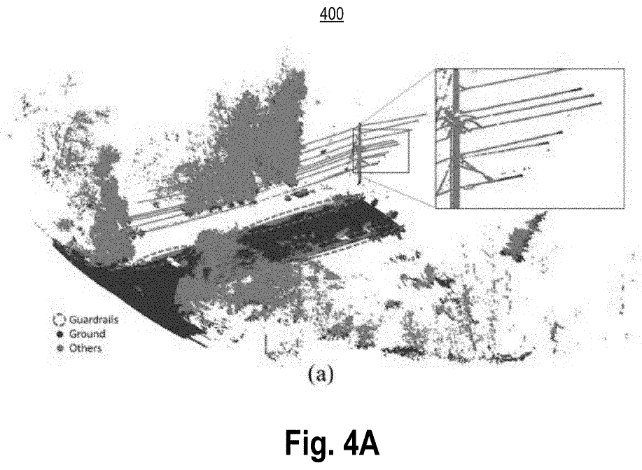

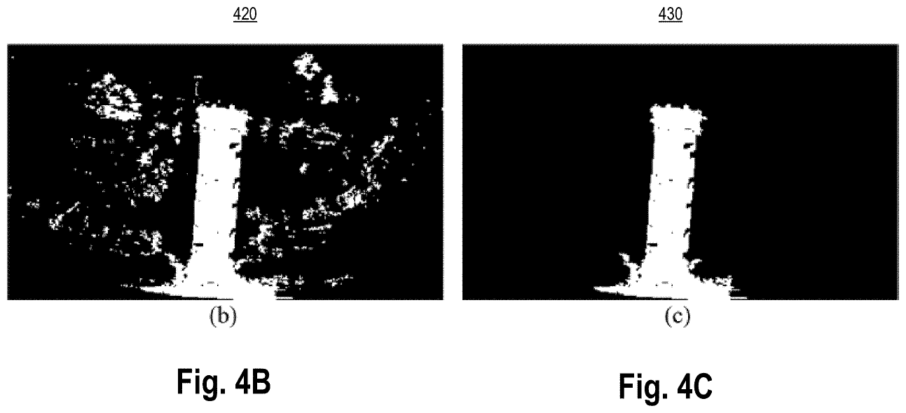

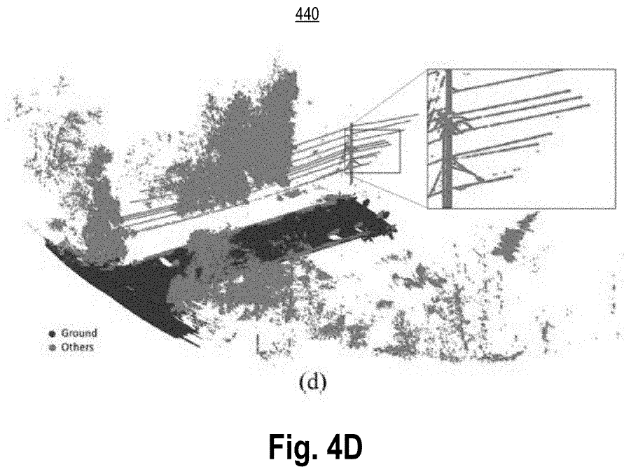

FIGS. 4A-D illustrate refinement of ground points over segmented ground points 400 in the powerlines, rasterization of ground points 420, detection of the largest segment 430, and refined ground points 440, respectively, in accordance with some embodiments. As discussed herein, ground filtering often over-segments the ground from non-ground objects in the areas distant from the scanner. As an example, in FIG. 4A, the ground surface outside the roadway is not captured due to the occlusions from the guardrails, causing the algorithm to over-segment the ground points at the lower portion of nonground objects. Whilst some of this problem could be overcome by modifying the algorithm settings or using a different approach, these artefacts will still occur in the areas away from the scanner setups with terrestrial data given the viewing geometry. To handle this problem, in some embodiments, the ground-filtered subsampled points are rasterized in the x-y plane using the cell size of s1 (FIG. 4B) to perform a connected component analysis that identifies isolated pixel groups. Small groups that do not connect with the largest one is removed (FIG. 4C). The ground points are then segmented according to their 2D locations as projected on the largest group as shown in FIG. 4D, such that the over-segmentation can be avoided. This process may result in some under-segmented ground points; however, those will be filtered in the next process described herein.

Height Filtering: Height filtering is used to remove unwanted objects within a certain height range above the ground. The objective is to preserve only the subsampled points located between the predefined minimum and maximum heights. Because of occlusions or an incomplete scan, the ground segment often suffers from under-segmentation. To that end, some embodiments use a Laplacian algorithm which interpolates the unoccupied ground segment by calculating the weighted average of its neighbors.

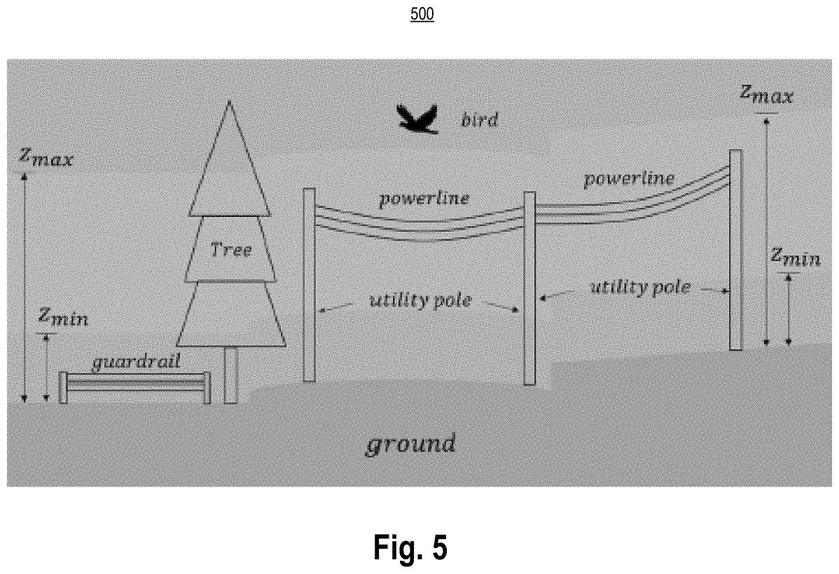

Ground-filtered subsampled points may still include some unwanted objects adjacent to the ground. Thus, a height constraint is specified to preserve only the subsampled points located between the predefined minimum and maximum heights (zₘᵢₙ and zₘₐₓ) above the ground (FIG. 5). FIG. 5 illustrates conceptual illustration 500 of the height constraint. To determine zₘᵢₙ, the users need to consider the vertical clearance of powerlines to the ground, which varies depending on local requirements, pole/line configurations, and utility line characteristics. For example, according to the National Electrical Safety Code (NESC), the vertical clearance of the lowest-level powerline is standardized as 5.0 m in the USA, whereas it is given as 6.4 m in China. In this example, zₘᵢₙ is set at a reduced value of 4 m below that specified within the NESC standard. Because zₘₐₓ can vary depending on sites, we empirically set a large value of 30 m to ensure we did not miss any powerlines in the scene.

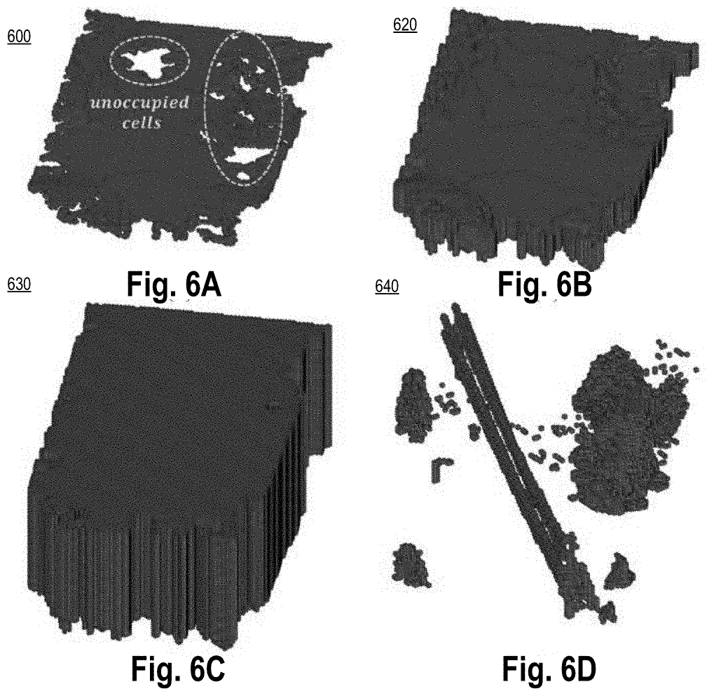

FIGS. 6A-D illustrate height filtering using a 3D morphological process with subsampled points for ground segment 600, ground segment enlarged with zₘᵢₙ 620, ground segment within the height constraint 630, respectively, in accordance with some embodiments. For cases in which the ground is not flat, some embodiments apply a method using a 3D morphological process. First, the ground-filtered subsampled points are organized into a 3D virtual grid structure as shown in FIG. 6A. Its cell size is the same as the spacing interval (s1) used for the voxel-based subsampling. Because of occlusions or an incomplete scan, the ground segment often includes some unoccupied cells (FIG. 6A) where interpolation is necessary to apply the height filtering to the objects located above the areas. To that end, some embodiments use a Laplacian algorithm which interpolates the unoccupied pixel by calculating the weighted average of its neighbors. Once the height values are interpolated, they are transformed into the virtual grid to fill the unoccupied cells. Note that, in FIG. 6A, only the unoccupied cells inside the ground segment are interpolated for visual purposes.

In some embodiments, it is desirable to interpolate all the unoccupied cells within the minimum boundary rectangle for the subsampled points to ensure the height filtering can be applied to the objects that fall outside the ground segment. Given the interpolated ground segment, a morphological dilation operation is performed using two vertical-line-shaped structuring elements with zₘᵢₙ and zₘₐₓ, resulting in two enlarged ground segments 620 and 630 as shown in FIG. 6B and FIG. 6C, respectively. By subtracting the enlarged segment with zₘᵢₙ from the one with zₘₐₓ, a new segment 640 can be generated to identify the objects within the height constraint as shown in FIG. 6D.

Feature-based Filtering: Feature-based filtering operation is used to remove unwanted objects near the powerlines. To speed up the process of feature computation, we incorporate a hierarchical approach using the subsampled points created with two spacing intervals. In the feature-based filtering phase, the powerline points in the object segment are separated from other objects. Given a set of points, 3D local geometric features (linearity (L), planarity (P), and scattering (S)) are derived from eigenvalues using the local neighborhood points. Subsequently, the points having higher linearity than other features (i.e., L>P and L>S) can be extracted as powerlines. To speed up the process of feature computation, we propose a hierarchical approach using the subsampled points created with two spacing intervals (s1 and s2). The details are as follows.

In the first phase, the subsampled points segmented in height filtering are organized into a k-d tree data structure. For each subsampled point, its k1 nearest neighbors are retrieved to compute the three local geometric features. A radius search is not considered in this study because some powerlines near other powerlines or noisy objects may lead to an incorrect classification, such as planarity or scattering. The spacing interval (s1) of the input subsampled points, which should be large enough to reduce the computational complexity in the ground filtering and height filtering phases. However, in the k nearest neighbor (kNN) search, a large spacing interval often finds the neighbors from adjacent parallel powerlines, making some powerline points have strong planarity.

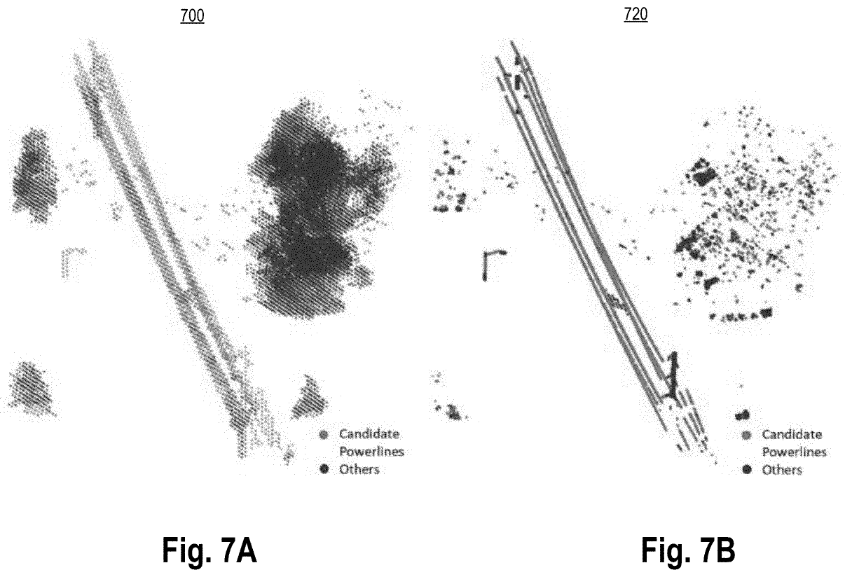

FIGS. 7A-B illustrate feature-based filtering using subsampled points with a larger spacing interval (s1) of 0.5 m 700, and with a smaller spacing interval (s2) of 0.1 m 720, respectively, in accordance with some embodiments. In the first phase, the subsampled points with both strong linearity or planarity (i.e., L>S or P>S) are extracted as candidate powerline points, which greatly reduces the subsampled points with strong scattering, often returned from trees, as shown in FIG. 7A.

In the second phase, the original scan points are segmented according to their 3D locations relative to the remaining subsampled points and then transformed back to a new set of subsampled points using a finer spacing interval (s2). The new subsampled points are likewise organized using a k-d tree to compute the local geometric features from k2 nearest neighbors. Subsequently, in this phase, merely the subsampled points with strong linearity (i.e., L>P and L>S) are extracted as candidate powerline points. Since many noise points are filtered in the first phase, the computational loads needed for the kNN search and the geometric-feature computation can be greatly reduced in the second phase. FIG. 7B shows an example of the candidate powerline subsampled points. Several parameters (s1, k1, s2, and k2) are involved in the hierarchical feature-based filtering, which are discussed herein.

Image-based filtering: In some embodiments, in image-based filtering operation small noise objects are filtered around the powerlines. In some embodiments, the candidate powerline scan points are rasterized onto a 2D binary image to identify the isolated pixel groups using the connected component process. For each group, we fit an ellipse by computing the 2nd order moments to discard any groups with the length of its ellipse's major axis less than the predefined value as noise. Subsequently, we segment the scan points according to their 2D horizontal locations on the filtered binary image and used them as the input for the next clustering and fitting processing.

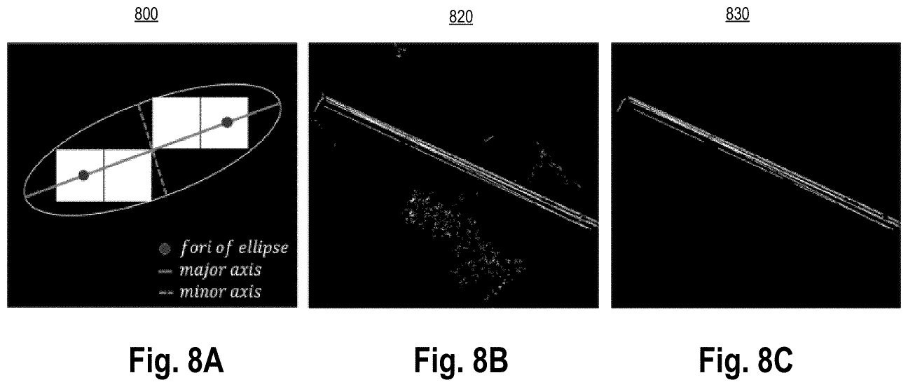

FIGS. 8A-C illustrate image-based filtering in a binary image with ellipse fitting for each segment 800, and powerlines before filtering small pixel groups 820, and powerlines after filtering small pixel groups 830, respectively, in accordance with some embodiments. Assuming that powerlines are long and straight lines horizontally, they are detected in the x-y plane using a single length threshold (l). Note that the input for image-based filtering is the scan points recovered from the candidate powerline subsampled points; hereafter, the subsampled points are no longer used to avoid the potential loss-of-detail. The candidate powerline scan points are rasterized onto a 2D binary image using the cell size of s2. A connected component process is performed on the binary image to identify the isolated pixel groups. For each group, an ellipse is fitted by computing the 2nd order moments (FIG. 8A). Subsequently, any groups with the length of its ellipse's major axis less than l are discarded as noise (FIG. 8B and FIG. 8C). The scan points are segmented according to their 2D horizontal locations on the filtered binary image and used as the input for the next clustering and fitting processing. When using a low-density point cloud, this process may increase the broken sections (false negatives) in the powerlines; nevertheless, these are recovered as described herein.

Clustering and Fitting: In this stage, the filtered, but unorganized candidate powerline points are grouped into a set of clusters using the Euclidean distance clustering algorithm (Ubbink, 2019), which ensures the minimum distance between the clusters is greater than the predefined distance (Δ). Subsequently, a mathematical model is fit to each cluster that can be further utilized to re-cluster individual powerlines and to recover broken sections. To that end, the powerline candidate points are translated to the local coordinate system by subtracting the centroid as follows:

x′=x−mean(x)

y′=y−mean(y) (2)

Each cluster is sequentially fitted with the straight line in horizontal plane and the 2nd order polynomial in the vertical plane. First, the straight-line model is defined as follows:

x′ cos(α)+y′ sin(α)−r=0 (3)

where x′ and y′ are the translated x and y coordinates of the scan points in Eq. (2), and r and α are the range and angle of the line model and can be estimated in the generalized least-squares sense. To reduce noise clusters, the root means square error (RMSE) of the fitted line model is calculated; if the RMSE is greater than the predefined threshold of tau, the cluster is discarded. Otherwise, using the orientation of a, the cluster is rotated to be aligned with the y″-z plane to fit the 2^{nd} order polynomial model as:

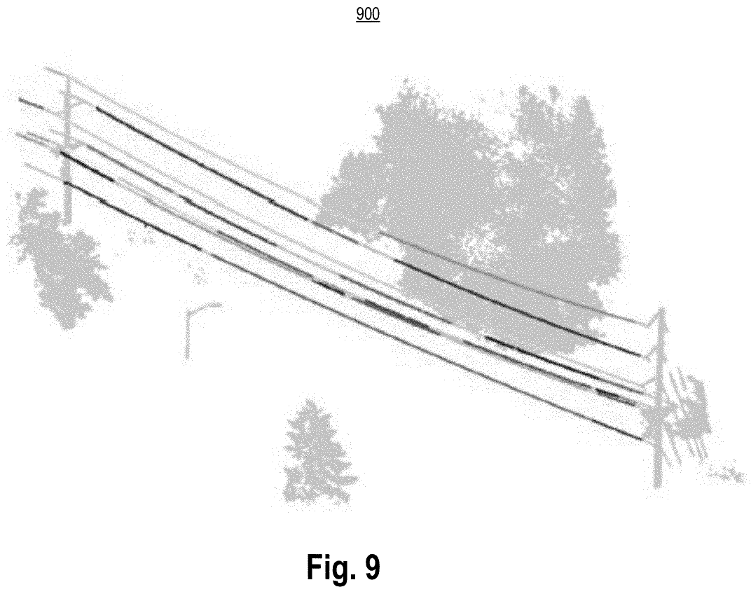

β₁y″²+β₂y″+β₃−z=0 (4)

where y″ is the rotated y′ coordinate of the scan points, z is the height value of the scan points, and β₁, β₂, and β₃ are the estimated coefficients of the 2nd order polynomial model. A least-squares polynomial-fitting is applied; if the RMSE of the fitted model is greater than tau τ, the selected cluster is discarded. Additionally, considering the sagging posture of the powerlines, if the cluster's polynomial opens downward (i.e., β₁<0), the cluster is discarded. As shown in FIG. 9, the proposed fitting may increase the broken sections in the powerline, but those will be recovered through the process in the next two sections. FIG. 9 illustrates initial clustering results 900 of candidate powerline points where each individual cluster is presented by a unique color, in accordance with some embodiments. The clustering and fitting operation of various embodiments require two parameters: the distance (Δ) and fitness (τ) thresholds. The selection of those parameters is discussed in more detail herein.

Powerline identification: In this phase, to identify the individual powerlines, the over-segmented clusters on the same powerline are re-clustered according to the following four conditions: (1) fitness of the straight line in the x′-y′ plane, (2) fitness of 2nd order polynomial in y″-z plane, and (3) evaluation of the leading coefficient of the 2nd order polynomial, and (4) adjacency of two different clusters.

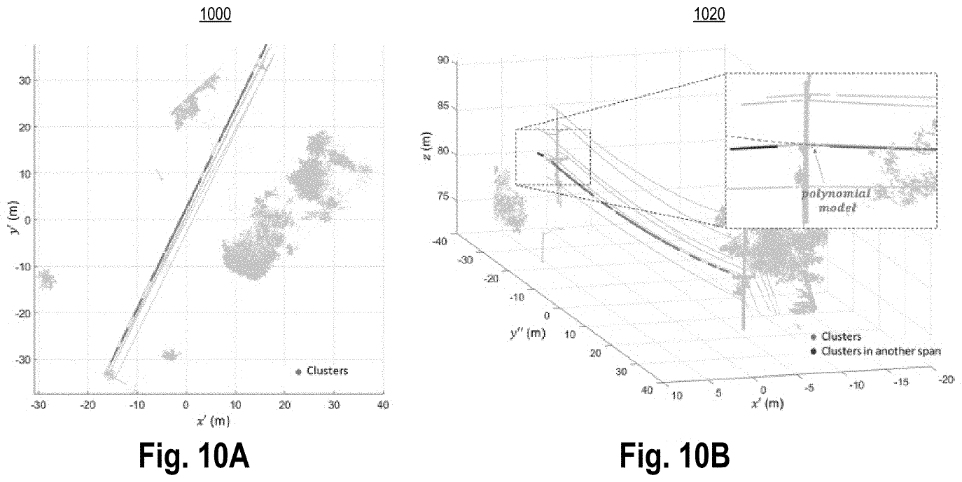

First, all the remaining clusters are labeled with different integer numbers as C_{i=1:m}. One cluster (CO is selected and sequentially paired with the remaining clusters (C_{j=i+1:m}) to generate the combined clusters (Cₖ←Cᵢ+Cⱼ). Subsequently, the straight-line model in Eq. (3) is fitted to Cₖ to discard the combined clusters with the RMSE greater than τ. FIG. 10A-B illustrate combined clusters 1000 in the horizontal plane, and combined clusters 1020 in the vertical plane, in accordance with some embodiments.

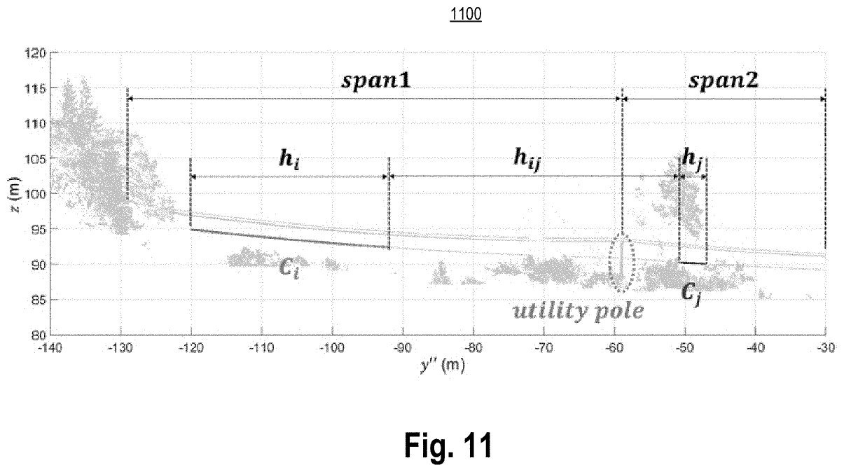

The remaining clusters identified on the same straight line are shown in FIG. 10A, but in a side view, some clusters may be suspended in different spans (FIG. 11). FIG. 11 illustrates an example of clusters 1100 that are on the same straight line in the horizontal plane, but suspected in different spans, in accordance with some embodiments. To cope with this situation, the remaining combined clusters are rotated and aligned in the y″-z plane to sort the scan points along the y″-axis, enabling identification of the two end points of each cluster. Subsequently, the horizontal distance between Cᵢ and Cⱼ can be calculated from the two closest end points between the clusters.

If the horizontal distance is greater than the horizontal length of the combined cluster (i.e., hᵢⱼ>hᵢ+hⱼ in FIG. 11), the combined cluster is discarded. A least squares polynomial-fitting in Eq. (4) is applied to discard the clusters with the RMSE greater than τ. This enables the identification of incorrect clusters that are on the same polynomial curve but suspended in a different span (FIG. 10B). Finally, considering the sagging posture of the powerlines based on weight and loading, the combined clusters opening downward (i.e., β₁<0) are discarded.

The algorithm may produce multiple combined clusters (Cₖ=1:n) with respect to Cᵢ. If so, the adjacency of Cᵢ and Cⱼ in each combined cluster is evaluated for prioritization: Cₖ is sorted in ascending order of the horizontal distance (hᵢⱼ), and Cᵢ is replaced with the first combined cluster (i.e., Cᵢ←Cₖ₌₁), which means that merely the closest Cⱼ is selected and combined into Cᵢ. As the iteration step increases, the remaining clusters (C_{j=i+1:m}) are re-evaluated with new Cᵢ, such that the distant clusters can eventually be considered. If no combined clusters are found with respect to Cᵢ, the algorithm updates the index (i=i+1) to perform the clustering with respect to the next cluster of Cᵢ. The algorithm is repeated until there are no more combined clusters to be paired (i.e., i=m). Algorithm 1 includes the details of the proposed re-clustering method.

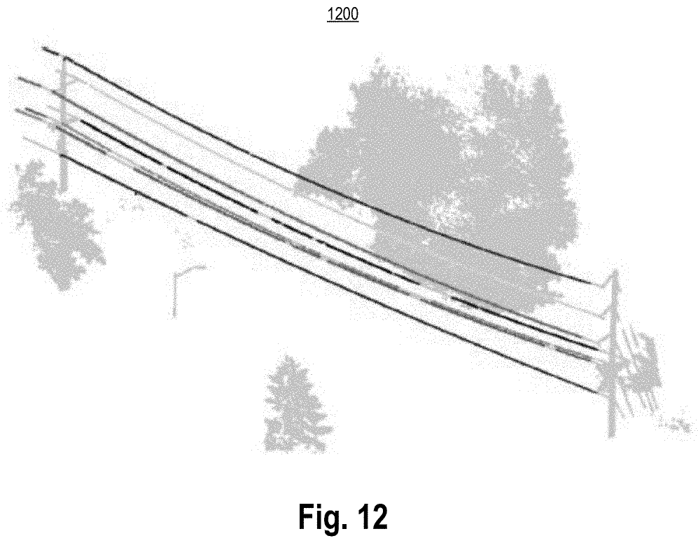

FIG. 12 illustrates identified powerlines 1200 with some broken sections, where each individual powerline is represented with a different color, in accordance with some embodiments. FIG. 12 provides an example of the individual powerlines identified using the proposed method. This process requires one input parameter (x), which is the same as the fitness threshold, as described herein.

Algorithm 1. Re-clustering of candidate powerline point clusters:

| | |
|---|---|
| 1. | Input: candidate powerline point clusters |
| | Output: individual powerlines |
| | Parameter: τ |
| 2. | Set i ← 1 |
| 3. | While i < m, where m is the total number of clusters |
| 4. | For j = i + 1:m |
| 5. | Set Cₖ ← Cᵢ + Cᵢ |
| 6. | If τ > RMSE of straight-line fitting to Cₖ |
| 7. | If τ > RMSE of 2^{nd} order polynomial fitting to Cₖ |
| 8. | If 0 < β₁ of 2^{nd} order polynomial model of Cₖ |
| 9. | If the horizontal distance (hᵢⱼ) < the horizontal length (hᵢ + hⱼ) |
| 10. | Save current Cₖ |
| 11. | End For |
| 12. | If C_{k=1:n} is not empty, where n is the total number of combined clusters with |
| | respect to Cᵢ |
| 13. | Sort C_{k=1:n} in ascending order of hᵢⱼ |
| 14. | Set Cᵢ ← Cₖ₌₁ |
| 15. | Remove Cⱼ |
| 16. | m=m−1 |
| 17. | Else |
| 18. | Set i ← i+1 |
| 19. | End While |
| 20. | Return C_{i=1:l}, where 1 is the total number of refined clusters. |

Powerline reconstruction: Powerline reconstruction operation is used to recover broken sections. To recover the broken sections in the powerlines, a neighbor search followed by an incremental search is proposed. Prior to reconstruction, the non-ground scan points are segmented according to the 3D locations of the non-ground subsampled points. In the neighbor search phase, the orthogonal distances of the non-ground scan points to the straight-line model fitted to each refined cluster are calculated in the x′-y′ plane to find the points closer than the predefined distance (δ). Subsequently, using the orientation of the straight line, the scan points within are rotated to be aligned with the y″-z plane. The neighbor search continues by using the 2nd order polynomial fitted to the cluster points in y″-z plane; if the vertical distances of the rotated non-ground scan points are within δ, and they are segmented as candidate powerline points.

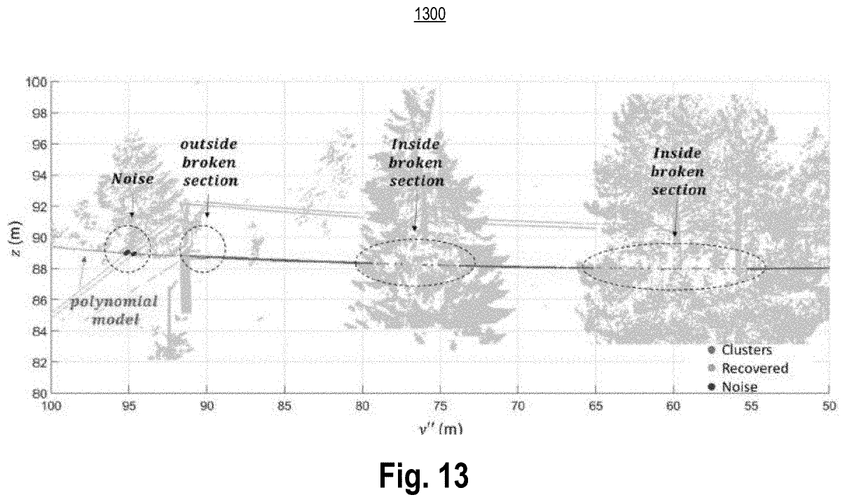

FIG. 13 illustrates a reconstruction of powerlines 1300 in the vertical plane, in accordance with some embodiments. The neighbor search sometimes includes some noise points (blue points in FIG. 13) that fall within the threshold distance from the mathematical models but fall far from the cluster (red points in FIG. 13). To address this problem, the broken sections are recovered separately as inside and outside sections. First, the candidate powerline points are segmented as inside broken section if their rotated y values (i.e., y″) lie within the two furthest points of the cluster in y″-axis. Second, to recover the outside broken sections, the cluster in y″-z plane is extended iteratively on both sides in A increments at a time. The incremental search stops when no candidate powerline points are detected within A to avoid the inclusion of noise points that fall far from the cluster.

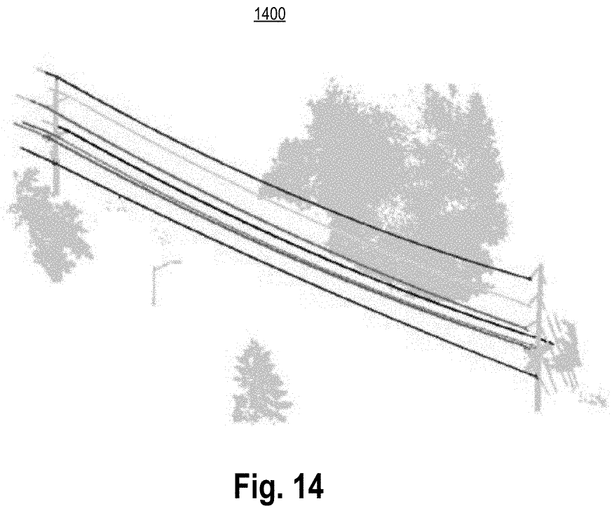

FIG. 14 illustrates fully reconstructed powerlines 1400, where each individual powerline is represented with a different color, in accordance with some embodiments. The proposed reconstruction uses two user parameters, δ and Δ, for the neighbor and the incremental searches, respectively. δ is determined through a sensitivity analysis, whereas A is the same as the parameter used for the initial clustering. FIG. 14 shows an example of the reconstructed powerlines. The final product is a 3D point cloud with unique labels for each powerline.

The proposed approach was tested on various datasets acquired in the cities of Mulino, Salem, and Philomath, located in Oregon, USA, using the Oregon Department of Transportation's (DOT) MLS system (Leica Pegasus 2) and a Leica ScanStation P40 TLS system (Table 2).

TABLE 2

| | Scanner type | | | | |
|---|---|---|---|---|---|
| | MLS | | | | TLS |
| | (Leica Pegasus 2) | | | | (Leica P40) |
| | Site | | | | |
| | Mulino 2016 | Mulino 2018 | Salem | Philomath | Mulino 2019 |
| Date | Apr. 18, 2016 | Jul. 13, 2018 | Jul. 10, 2017 | Jul. 19, 2017 | Mar. 24, 2019 |
| Vehicle speed | 40-70 | 50-70 | 40-60 | 40 | — |
| (km/h) | | | | | |
| Scanner | 0 | −30/+60 | −30 | −30 | — |
| orientation (°) | | | | | |
| Sensor mode | Single | Dual | Single | Single | — |
| (single or dual) | | | | | |
| # of total | 56,746,286 | 110,795,980 | 106,677,205 | 108,159,249 | 284,113,536 |
| scan points | | | | | |
| # of | 302,754 | 425,296 | 372,059 | 392,096 | 883,567 |
| powerline points | | | | | |
| Point density | 92.16-325.70 | 202.80-334.12 | 187.14-338.31 | 278.05-574.46 | 297.11-883.21 |
| (points/m3) | | | | | |
| Minimum distance | 0.23-1.00 | 0.14-0.59 | 0.27-1.14 | 0.13-1.96 | 0.31-1.59 |
| between | | | | | |
| powerlines (m) | | | | | |
| # of tiles (or | 6 | 6 | 6 | 6 | 6 |
| stations) used | | | | | |

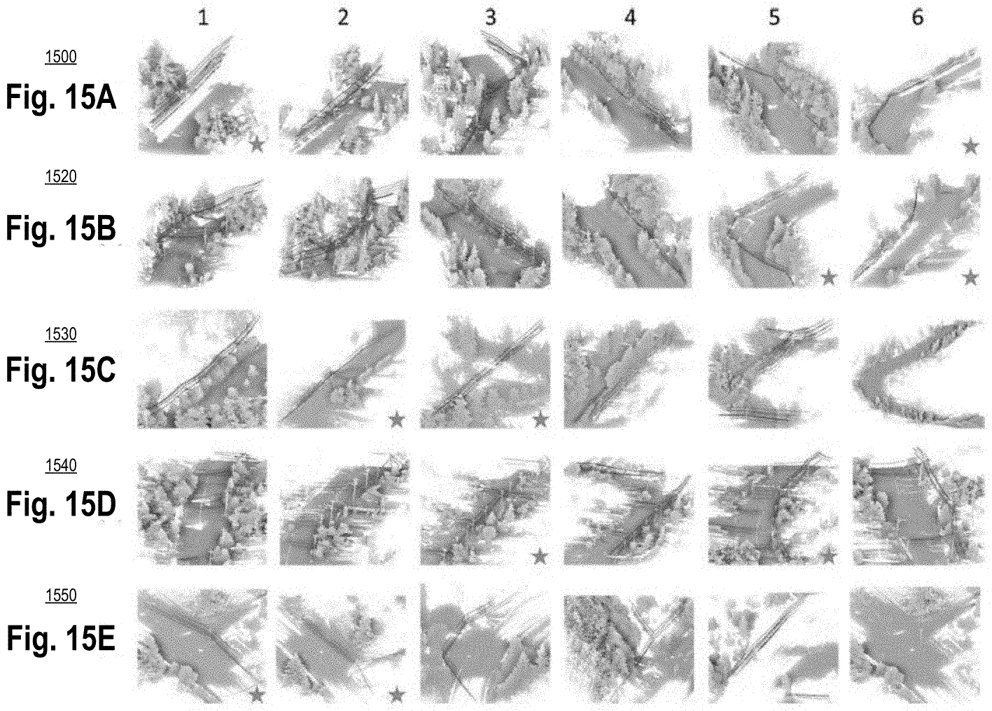

Note that Oregon DOT's MLS system supports a dual laser profiler mode with increased point density. After data acquisition, the MLS data is discretized into smaller sections, called a “tile”, along the direction of the travel path to maintain a data size less than either 10 or 20 million points depending on the application, whereas the data size of TLS data varies depending on the scanner configuration. FIGS. 15A-E show the point cloud datasets 1500, 1520, 1530, 1540, and 1550, respectively, used for the evaluation of the proposed approach. FIGS. 15A-E illustrate point cloud data acquired using MLS in Mulino in 2016, Mulino in 2018, Salem, Philomath, and using TLS in Mulino in 2019, respectively. For ground truthing, the powerlines (color-coded with red) are labeled manually using the classification features in Maptek I-Site Studio 7.0.

The Mulino 2016 and 2018 data encompass a state highway that runs the north-south route between the cities of Portland and Salem. The powerlines in Mulino tend to represent forest and rural areas with a vertical powerline configuration (i.e., multiple powerlines are vertically aligned with different heights but have same profile in the horizontal plane.) A total of six tiles were obtained in 2016 with a single laser profiler and another six tiles in 2018 with the dual profiler, respectively. The Salem data were acquired in 2017 with the single profiler for a section of the Oregon DOT mobile laser scanning test course located in Salem. A total of 16 tiles were acquired. After visual inspection, five of those tiles were selected because they included powerlines, and one tile without powerlines was also selected to verify that the approach is robust to false positives (FIG. 15C-6). The Salem data represent rural areas, including both vertical and horizontal powerline configurations (the latter indicates that multiple powerlines are horizontally aligned with same heights but different profiles in the horizontal plane).

The Philomath data were acquired in 2017 with the single profiler for a section of the Corvallis-Newport Hwy (Westbound), east of N 20th St. One particular challenge with the Philomath data is that it runs the residential area, representing a complicated configuration of powerlines and substantial sources of noise. The Mulino 2019 data were acquired with TLS. The powerlines at this site have a vertical powerline configuration, and the site also includes a densely-forested area with a steep slope (FIG. 15E-4). To test the approach on the TLS data including no powerlines, the first station (FIG. 15E-1) was modified to remove the powerlines (FIG. 15E-6). The detailed configurations of the MLS and TLS systems for different test sites are listed in Table 2. Note that the number of scan and powerline points in the table comprises the six tiles (or stations) for each site.

Table 3 lists the proposed approach's input parameters obtained in three different ways: literature, empiric, and sensitivity analysis.

TABLE 3

| | | | | | | | | Density | |
|---|---|---|---|---|---|---|---|---|---|
| | | | | | | | | of | # of |
| | | | | F1 | Efficiency | | # of | ground | subsampled |
| | | Precision | Recall | score | (million | # of | ground | truth | ground |
| Site | Dataset | (%) | (%) | (%) | points/sec) | points | truth | (points/m³) | truth |
| Muhno | a-1 | 97.17 | 97.92 | 97.54 | 1.43 | 9,116,548 | 78,783 | 83.63 | 1,681 |
| 2016 | a-2 | 92.09 | 82.66 | 87.12 | 0.96 | 9,575,135 | 85,822 | 47.31 | 3,065 |
| | a-3 | 98.72 | 84.55 | 91.09 | 0.53 | 9,517,368 | 70,842 | 24.27 | 5,079 |
| | a-4 | 98.31 | 67.74 | 80.21 | 1.03 | 9,498,886 | 20,198 | 12.92 | 2,483 |
| | a-5 | 100.00 | 64.67 | 78.55 | 1.27 | 9,349,066 | 10,550 | 17.44 | 1,004 |
| | a-6 | 97.47 | 58.87 | 73.41 | 1.43 | 9,689,283 | 36,559 | 19.39 | 3,105 |
| Total | — | 96.19 | 82.58 | 88.87 | 0.98 | 56,746,286 | 302,754 | 31.12 | 16,417 |
| Muhno | b-1 | 97.31 | 92.59 | 94.89 | 0.60 | 18,289,803 | 121,652 | 27.14 | 7,709 |
| 2018 | b-2 | 95.85 | 92.08 | 93.93 | 0.62 | 18,372,713 | 133,469 | 36.30 | 6,451 |
| | b-3 | 97.55 | 84.60 | 220.61 | 1.07 | 18,381,203 | 71,039 | 23.24 | 4,980 |
| | b-4 | 220.98 | 76.74 | 83.26 | 1.53 | 18,163,842 | 19,993 | 21.34 | 1,508 |
| | b-5 | 97.07 | 91.91 | 94.42 | 1.34 | 18,694,373 | 43,722 | 27.41 | 2,786 |
| | b-6 | 95.91 | 64.18 | 76.220 | 1.81 | 18,894,046 | 35,421 | 17.05 | 3,570 |
| Total | — | 96.48 | 87.91 | 92.00 | 0.97 | 110,795,980 | 425,296 | 26.87 | 27,004 |
| Salem | c-1 | 97.39 | 99.85 | 98.61 | 1.29 | 17,771,765 | 57,839 | 60.31 | 1,647 |
| | c-2 | 97.17 | 80.34 | 87.96 | 1.10 | 18,182,117 | 30,360 | 29.74 | 1,732 |
| | c-3 | 98.41 | 99.50 | 98.95 | 1.04 | 17,804,227 | 125,891 | 80.08 | 2,674 |
| | c-4 | 98.24 | 84.51 | 220.86 | 0.56 | 17,031,073 | 76,2204 | 27.11 | 4,666 |
| | c-5 | 97.79 | 92.49 | 95.07 | 0.52 | 17,289,939 | 81,065 | 27.27 | 5,101 |
| | c-6 | — | — | — | 1.21 | 18,598,084 | — | — | — |
| Total | — | 96.76 | 93.37 | 95.03 | 0.84 | 106,677,205 | 372,059 | 39.74 | 15,820 |
| Plhlomath | d-1 | 88.46 | 79.55 | 83.77 | 1.52 | 18,279,198 | 22,158 | 29.78 | 1,244 |
| | d-2 | 89.76 | 95.08 | 92.34 | 1.57 | 19,428,2204 | 44,934 | 54.27 | 1,399 |
| | d-3 | 94.42 | 66.44 | 77.99 | 1.51 | 19,245,680 | 42,945 | 26.12 | 2,600 |
| | d-4 | 96.87 | 94.52 | 95.68 | 0.80 | 19,242,354 | 120,693 | 43.67 | 4,798 |
| | d-5 | 94.78 | 93.80 | 94.29 | 0.76 | 19,120,484 | 11,8422 | 37.55 | 5,511 |
| | d-6 | 97.36 | 77.31 | 86.19 | 1.36 | 12,842,629 | 42,944 | 21.00 | 3,304 |
| Total | — | 94.67 | 88.56 | 91.51 | 1.13 | 108,159,249 | 392,096 | 35.07 | 18,856 |
| Muhno | e-1 | 91.10 | 98.30 | 94.56 | 2.49 | 40,965,411 | 191,358 | 456.70 | 687 |
| 2019 | e-2 | 99.33 | 99.11 | 99.22 | 2.34 | 40,732,202 | 153,237 | 333.85 | 732 |
| | e-3 | 92.44 | 98.51 | 95.38 | 1.66 | 56,542,480 | 193,636 | 228.08 | 1,430 |
| | e-4 | 88.65 | 93.98 | 91.24 | 1.40 | 63,585,289 | 165,723 | 258.14 | 1,123 |
| | e-5 | 96.48 | 98.17 | 97.32 | 1.04 | 41,514,101 | 188,888 | 102.88 | 3,034 |
| | e-6 | — | — | — | 2.63 | 40,774,053 | — | — | — |
| Total | — | 93.39 | 97.65 | 95.47 | 1.68 | 284,113,536 | 892,842 | 213.16 | 7,006 |

In this study, zₘᵢₙ was determined at a reduced value of 4 m compared with the standards in the USA (Guan et al., 2016), whereas a large value of 30 m was empirically determined for zₘₐₓ to ensure we did not miss any powerlines in the scene. The other parameters are determined through a sensitivity analysis of the test variables listed in Table 3. Prior to the sensitivity analysis, we performed preliminary experiments to identify two representative datasets for each site (marked with stars in FIGS. 15A-E): one representing the highest F1 score and the other one representing the lowest F1 score, respectively, to maintain balance during the parameter optimization. The sensitivity analysis was performed separately for each main phase (i.e., candidate powerline point extraction and refinement) using 10 datasets marked in FIGS. 15A-E. In particular, we investigated all the combinations of four parameters with five test variables, resulting in a total of 54=625 combinations for each main phase. The proposed method was implemented in MATLAB and the experiment was performed on a computer with an Intel Xeon W-2145 CPU (3.7 GHz, 64 GB RAM).

With the optimized parameters for the candidate powerline point extraction phase (s1: 0.6 m, k1: 10, s2: 0.09 m, k2: 10), we investigated the sensitivity of the input parameters of l, Δ, δ, τ, and δ for the refinement phase. The test variables for l were set between 1.0 and 5.0 m in 1.0 m increments. The larger the values, the more the false positives are discarded in the image-based filtering, but too large of a value may also increase the number of false negatives. The test variables were set for between 0.1 and 0.5 m in 0.1 m increments. The larger the values, the less the candidate powerline point clusters are segmented, enabling the computational complexity to be reduced. However, too large of a value may increase the chance of merging the false positives, and the clusters play a key role to determine clusters on the same powerline. Its test variables were investigated between 0.02 and 0.1 m in 0.02 m increments, where the minimum value was determined considering the MLS scanner accuracy (typically 0.02 m RMS for Leica Pegasus, Two in ideal conditions (Leica Geosystems, 2018)). The larger the values, the more the clusters are combined, but too large of a value may combine the clusters in different powerlines. Finally, the test variables were set from 0.04 to 0.2 m in 0.04 increments. The larger the values, the more the scan points are included to recover the broken sections in the powerlines, but too large of a value may include more false positives near the powerlines.

Although the 10 datasets used in the sensitivity analysis include some powerlines whose adjacent minimum distances (Table 2) are less than 0.2 m, it is determined to be greater than those minimum distances because there are very few of those adjacent powerlines. While a too small distance produces several small and fragmented candidate powerline point clusters that may increase the failure rate in the re-clustering process, the distance tends to vary between 0.04 and 0.1 m, demonstrating that the performance of the proposed approach is less sensitive to distance once it is greater than the scanner accuracy.

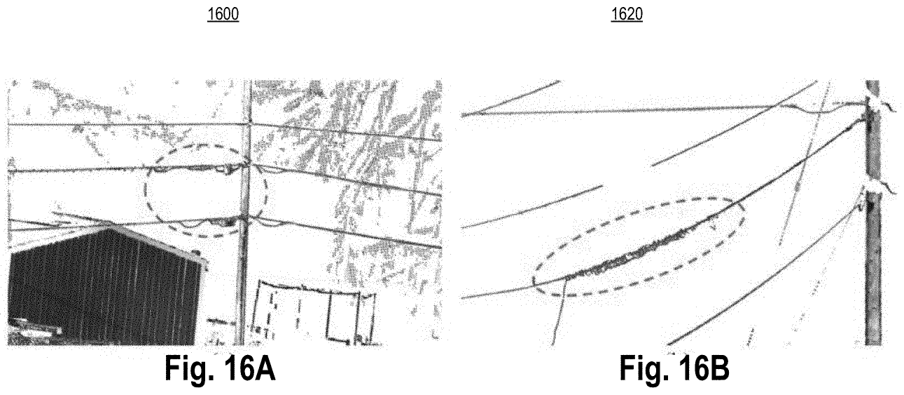

FIGS. 16A-B illustrate examples of powerlines including other objects of vibration dampers 1600, or multiple lines 1620, respectively, in accordance with some embodiments. The optimized values were found between 0.16 and 0.2 m, which are actually much larger than the diameter of ordinary powerlines. This is because some powerlines include other objects, such as vibration dampers (FIG. 16A), or multiple lines (FIG. 16B), that were segmented into the ground truth.

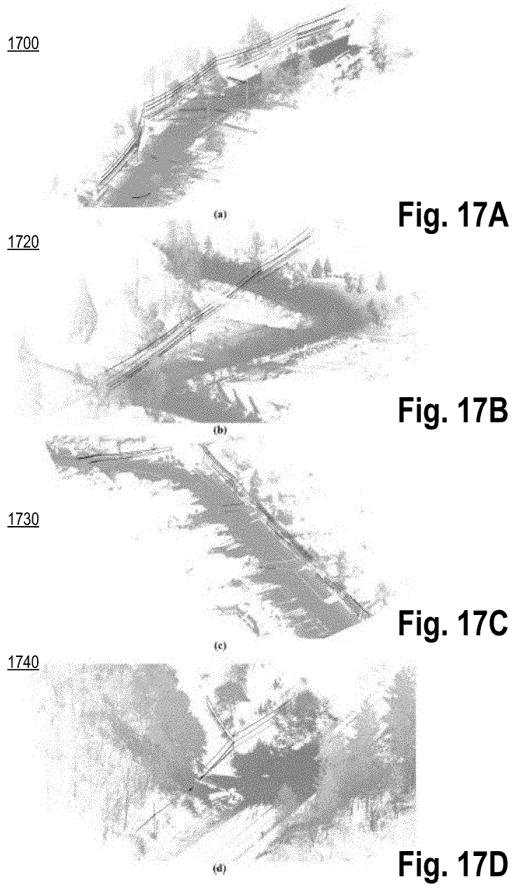

FIGS. 17A-D illustrate examples of extracted powerlines in the datasets of b-1 1700, c-3 1720, d-4 1730, and e-4 1740, respectively, in accordance with some embodiments. FIGS. 17A-D present some examples of the powerlines extracted with the optimized parameters determined from the sensitivity analysis. The density of the ground truth was calculated by dividing the number of ground truth by the volume occupied by the subsampled ground truth with the spacing interval of 1 m. In the experiments, the total precision and recall rates were calculated between 93.39% and 96.76% and between 82.58% and 97.65%, respectively. In terms of total F1 score, the highest and lowest measures were achieved with the Mulino 2019 datasets (95.47%) and with the Mulino 2016 datasets (88.87%), respectively. The poor results with some Mulino 2016 datasets (a-4, a-5, and a-6) are due primarily to the low-density powerline points (12.92-19.39 points/m3) acquired at fast speeds (approximately 70 km/h) with the single profiler mode, producing several small and fragmented powerline clusters that are removed together with other noise objects, ultimately resulting in low recall rates.

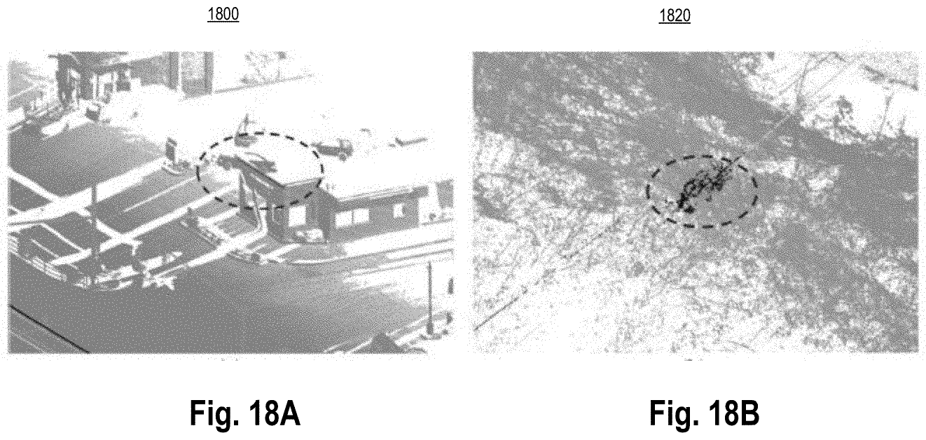

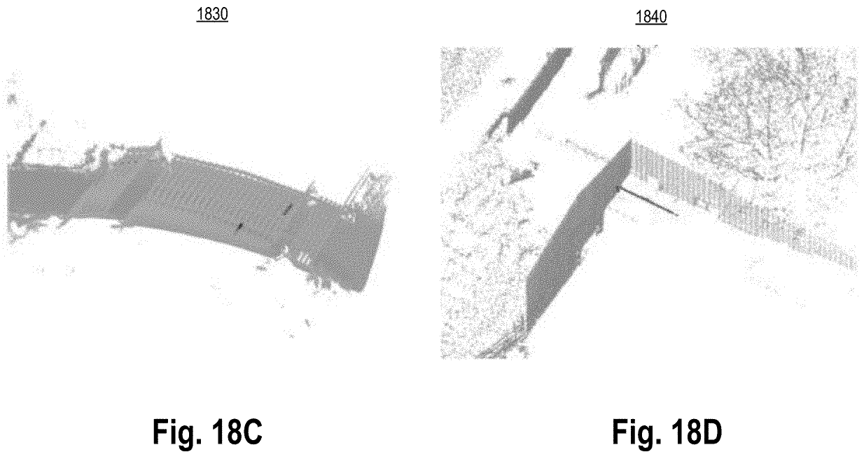

FIGS. 18A-B illustrate examples of false positives in the datasets with powerlines d-5 1800 and e-4 1820, respectively, according to some embodiments. FIGS. 18C-D illustrate false positives in the datasets without powerlines c-6 1830 and e-6 1840, in accordance with some embodiments.

The low recall rates are also found with some Mulino 2018 and Philomath datasets (b-4, b-6, and d-6) owing to the low density (17.05-21.34 points/m3) caused by the MLS systems operated in the lanes on the other side of where the powerlines exist. On the other hand, compared to the precision rates with Mulino 2016, 2018, and Salem datasets (96.19-96.76%), relatively lower precision rates are obtained with Philomath and Mulino 2019 datasets (93.39-94.67%). This is because Philomath is predominately residential areas including some linear shaped lamps and roof drainages that are incorrectly detected as powerlines (FIG. 18A), whereas some trees near the powerlines in Mulino 2019 are over-segmented into the powerlines when recovering the broken sections (FIG. 18B). The proposed approach produced some false positives for datasets without powerlines (c-6 and e-6). The number of false positive points was counted 4482 for c-6, which was due primarily to the linear-shaped girder of the tunnel shown in FIG. 18C, whereas only 220 points were detected for e-6 (FIG. 18D).

The total efficiency for each site was calculated between 0.81 and 1.46 million points/sec. Note that the efficiencies of datasets without powerlines (c-6 and e-6) are not counted for the total efficiencies. The highest and the lowest total efficiencies were achieved with the Mulino 2019 and the Salem datasets, respectively. With Mulino 2019, except for the dataset with no powerlines, the highest efficiency up to 2.18 million points/sec was achieved with the dataset e-2, whereas with Salem data, the lowest efficiency of 0.54 million points/sec was found with the dataset c-5.

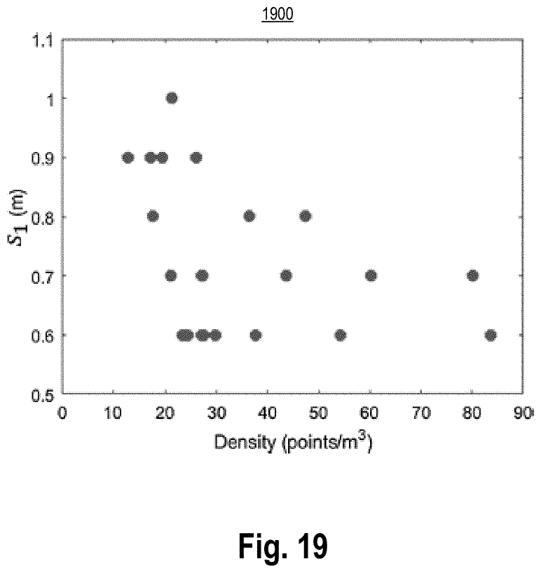

FIG. 19 illustrates plot 1900 showing change in S1 with respect to the density of ground truth for MLS data, in accordance with some embodiments.

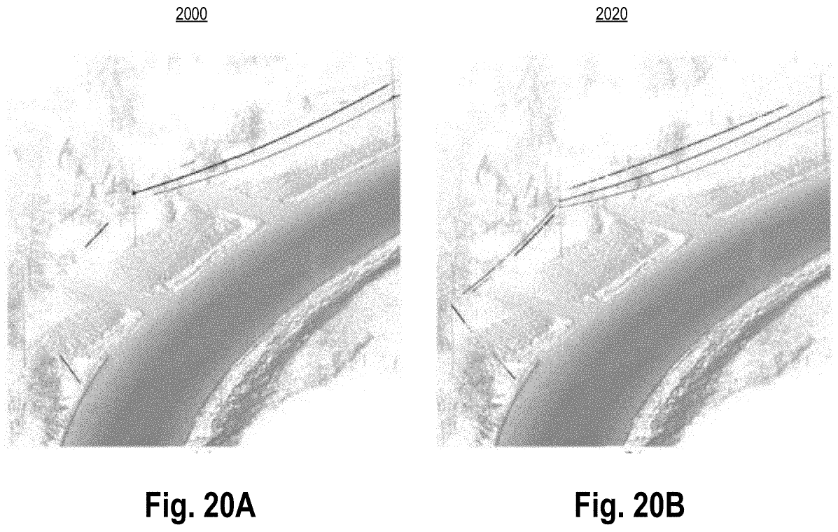

FIGS. 20A-B illustrate comparison of powerlines extracted from a-6 database using parameters optimized or all the datasets 2000, and for the low-density datasets only 2020, in accordance with some embodiments. FIGS. 20A-B compare the powerlines extracted from a-6 dataset using the parameters optimized for all the datasets and for the low-density datasets only, demonstrating the proposed approach exhibits better performance in the latter case. The minimum F1 score has increased from 73.41 to 83.19% with the newly optimized parameters. However, despite these improvements, the proposed approach was unable to maintain the higher recall rates achieved with the high-density datasets. Therefore, it is generally recommended to acquire MLS data at slower speeds (and dual profiler mode, if available) when possible to ensure the sufficient point density in the point clouds. In the present study, zₘᵢₙ is determined to be 4 m considering USA standards. In practice, however, there are some cases where the powerlines are too close to the ground, such that the standard vertical clearance does not work for the height filtering.

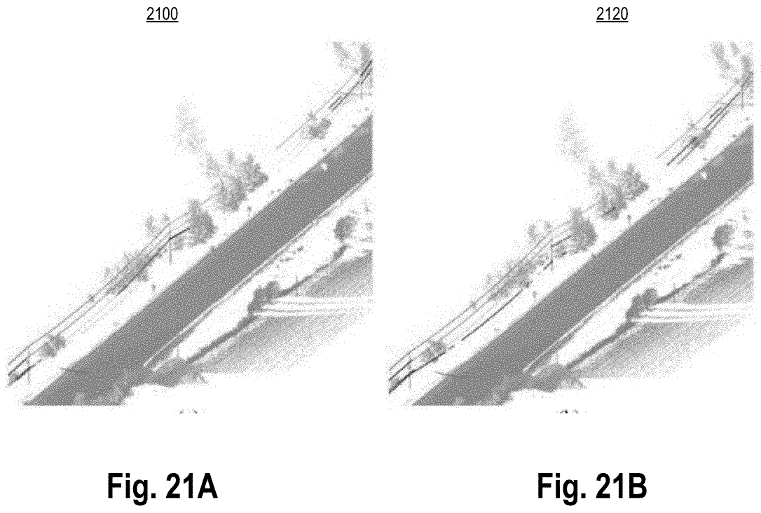

FIGS. 21A-B illustrate comparison of powerlines extracted from b-6 database using zₘᵢₙ of 4 m 2100, and 0 m 2120, respectively. FIGS. 21A-B compare the powerlines extracted from b-6 dataset using two different zₘᵢₙ of 4 m and 0 m, respectively. The recall rate has increased from 64.18 to 83.06%, whereas the efficiency has decreased from 1.81 to 1.14 million points/sec due to the increased object segment within the height constraint. Further, a decreased zₘᵢₙ may increase false positives specifically for datasets acquired in highways or urban areas because they include many linear-shaped objects, such as guardrails, near the ground. For example, when zₘᵢₙ is set to 0 m, it was found that the total precision rate for the Philomath datasets had decreased from 94.67 to 66.40% even with the optimized parameters. Hence, it is generally recommended to specify zₘᵢₙ according to the standards unless significant drops in accuracy are found for a specific dataset.

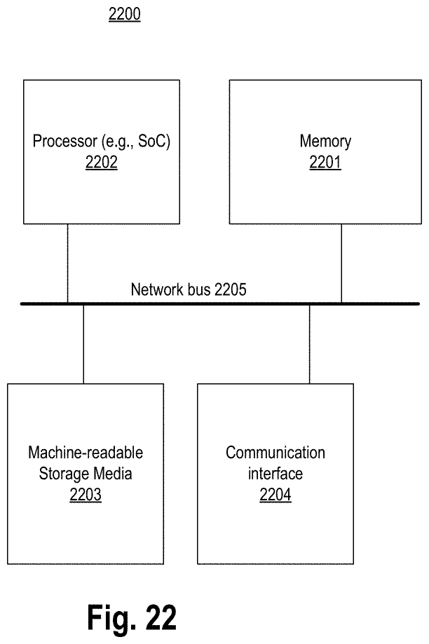

FIG. 22 illustrates a computer system 2200 with machine-readable media having machine executable instructions to perform a method extract powerlines from Lidar point cloud data, in accordance with some embodiments. Elements of embodiments are also provided as a machine-readable medium (e.g., memory) for storing the computer-executable instructions (e.g., instructions to implement any other processes discussed herein). In some embodiments, the computing platform comprises memory 2201, processor 2202, machine-readable storage media 2203 (also referred to as tangible machine readable medium), communication interface 2204 (e.g., wireless or wired interface), and network bus 2205 coupled together as shown.

In some embodiments, processor 2202 is a Digital Signal Processor (DSP), an Application Specific Integrated Circuit (ASIC), a general-purpose Central Processing Unit (CPU), or a low power logic implementing a simple finite state machine to perform the method of various embodiments, etc.

In some embodiments, the various logic blocks of the system are coupled together via network bus 2205. Any suitable protocol may be used to implement Network Bus 2205. In some embodiments, machine readable storage medium 2203 includes instructions (also referred to as the program software code/instructions) for extracting powerlines from lidar data as described with reference to various embodiments and flowchart.

Program software code/instructions associated with the methods and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with various embodiments are executed by the computing system.

In some embodiments, the program software code/instructions associated with various flowcharts are stored in a computer executable storage medium and executed by processor 2202. Here, computer executable storage medium 2203 is a tangible machine-readable medium that can be used to store program software code/instructions and data that, when executed by a computing device, causes one or more processors (e.g., processor 2202) to perform a method(s) as may be recited in one or more accompanying claims directed to the disclosed subject matter.

The tangible machine-readable medium 2203 may include storage of the executable software program code/instructions and data in various tangible locations, including for example, ROM, volatile RAM, non-volatile memory and/or cache and/or other tangible memory as referenced in the present application. Portions of this program software code/instructions and/or data may be stored in any one of these storage and memory devices. Further, the program software code/instructions can be obtained from other storage, including, e.g., through centralized servers or peer-to-peer networks and the like, including the Internet. Different portions of the software program code/instructions and data can be obtained at different times and in different communication sessions or in the same communication session.

The software program code/instructions and data can be obtained in their entirety prior to the execution of a respective software program or application by the computing device. Alternatively, portions of the software program code/instructions and data can be obtained dynamically, e.g., just in time, when needed for execution. Alternatively, some combination of these ways of obtaining the software program code/instructions and data may occur, e.g., for different applications, components, programs, objects, modules, routines or other sequences of instructions or organization of sequences of instructions, by way of example. Thus, it is not required that the data and instructions be on a tangible machine-readable medium in entirety at a particular instance of time.

Examples of tangible computer-readable media 2203 include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs), etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, tangible machine readable medium 2203 includes any tangible mechanism that provides (i.e., stores and/or transmits in digital form, e.g., data packets) information in a form accessible by a machine (i.e., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Galaxy®, Blackberry® Nexus®, or the like, or any other device including a computing device. In one embodiment, processor-based system is in a form of or included within a PDA (personal digital assistant), a cellular phone, a notebook computer, a tablet, a game console, a set top box, an embedded system, a TV (television), a personal desktop computer, etc. Alternatively, the traditional communication applications and subsidized application(s) may be used in some embodiments of the disclosed subject matter.

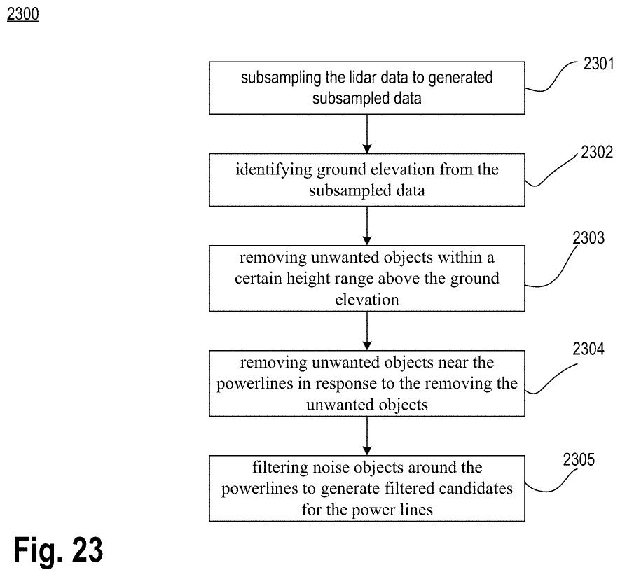

FIG. 23 illustrates a flowchart 2300 to extract powerlines from lidar data, in accordance with some embodiments. While the blocks here are presented in a certain order, the order can be modified. For example, some blocks may be performed before others while some blocks may be performed simultaneously. The various blocks can be performed by hardware, software, or a combination of them.

At block 2301, the lidar data is subsampled to generated subsampled data. At block 2302, ground elevation is identified from the subsampled. At block 2303, unwanted objects within a certain height range above the ground elevation are removed. At block 2304, unwanted objects near the powerlines are removed in response to the removing the unwanted objects. At block 2305, noise objects around the powerlines are filtered to generate filtered candidates for the power lines. In some embodiments, the method of extracting powerlines further comprises grouping the filtered candidates into a set of clusters using a Euclidean distance scheme. In some embodiments, the method of extracting powerlines further comprises fitting a model to each cluster of the set to re-cluster the filtered candidates for the powerlines. In some embodiments, fitting the model comprises translating points for the filtered candidates for the power lines into a local coordinate system by calculating a centroid.

In some embodiments, the method of extracting powerlines further comprises detecting individual powerlines from the filtered candidates by re-clustering over segmented clusters on the same powerlines. In some embodiments, the method of extracting powerlines further comprises reconstructing powerlines from the re-clustering the over segmented clusters. In some embodiments, the method subsampling the lidar data comprises applying voxel-based subsampling point cloud of the lidar data to generate voxel-based subsampled data. In some embodiments, the method of filtering noise objects comprises applying image-based filtering.

In summary, powerlines are an important device to distribute electricity from production facilities to communities. For periodic monitoring and maintenance purposes, there has been increasing interest in the application of point clouds for the reconstruction of powerlines. However, issues remain in handling the substantial number of point data, and dealing with noisy objects in close proximity the powerlines, which motivated us to develop an efficient and robust powerline extraction approach. The proposed approach can be divided into two main steps: candidate powerline point extraction, and refinement. In the candidate powerline point extraction step, we propose a hierarchical, voxel-based subsampling structure for substituting the original scan points, which significantly enhances efficiency. To improve the over-segmentation in the ground filtering, we proposed a simple, but effective method that rasterizes the point cloud in the x-y plane to apply the connected component analysis to identify the largest isolated pixel group as a ground. Subsequently, in the height filtering phase, the under-segmentation due to occlusions is improved by using the Laplacian interpolation. The remaining points are then segmented through the feature-based filtering, where we incorporated the hierarchical approach to achieve high processing efficiency while preserving the details of powerlines.

After that, the proposed 2D image-based filtering produces the candidate powerline points. In the refinement step, the candidate points are clustered and fitted with two mathematical models, which are later used to identify individual powerlines as well as recover the broken sections in the powerlines. With the optimized parameters, we achieved the total precision and recall rates of 93.39-96.76% and 82.58-97.65%, respectively, over 30 diverse datasets acquired in four different sites.

The hierarchical, voxel-based subsampling structure enables various embodiments to achieve high efficiency ranging from 0.81 and 1.46 million points/sec, which is much faster than state-of-the-art methods in the literature (0.003-0.31 million points/sec). The hierarchical approach is versatile and can potentially be integrated into other sampling methods, such as heuristic sampling, inverse density sampling, and learning-based sampling. The proposed approach is applicable to both MLS and TLS data without any supplemental data, such as vehicle trajectory, return number, intensity, or pre-classified data, thereby increasing the utility of the approach with significantly fewer constraints. The versatility of the proposed approach has been tested on a variety of point clouds with variable conditions, such as urban, rural, and forest areas, whereas most existing approaches are available only for specific areas. Further, to overcome the limitation of a heuristic parameter determination, we proposed a rigorous evaluation method that can account for all the combinations of test variables of parameters involved in each main step.

In addition to the powerline evaluation, there are several potential uses of the proposed approach, for example, position detection of catenary masts or utility poles, height measurement of the powerlines with respect to the ground, change detection of the powerlines extracted in different epochs over the same area, and clearance of point cloud with respect to the road. The extracted powerlines and other information could potentially be integrated into a Geographical Information System to further assist the end-users, which will be investigated in our future studies.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art considering the foregoing description. The embodiments of the disclosure are intended to embrace all such alternatives, modifications, and variations as to fall within the broad scope of the appended claims.

Following examples are provided that illustrate the various embodiments. The examples can be combined with other examples. As such, various embodiments can be combined with other embodiments without changing the scope of the invention.

Example 1: A machine-readable storage media having machine readable instructions stored thereon that when executed cause one or more machines to perform a method to extract powerlines from lidar data, the method comprising: subsampling the lidar data to generated subsampled data; identifying ground elevation from the subsampled data; removing unwanted objects within a certain height range above the ground elevation; removing unwanted objects near the powerlines in response to the removing of the unwanted objects; and filtering noise objects around the powerlines to generate filtered candidates for the powerlines.

Example 2: The machine-readable storage media of example 1, having machine readable instructions stored thereon that when executed cause one or more machines to perform a further method comprising: grouping the filtered candidates into a set of clusters using a Euclidean distance scheme; and fitting a model to each cluster of the set of clusters to re-cluster the filtered candidates for the powerlines.

Example 3: The machine-readable storage media of example 2, wherein fitting the model comprises: translating points for the filtered candidates for the powerlines into a local coordinate system by calculating a centroid.

Example 4: The machine-readable storage media of example 3, having machine-readable instructions stored thereon that when executed cause one or more machines to perform a further method comprising: detecting individual powerlines from the filtered candidates by re-clustering over segmented clusters on same powerlines; and reconstructing powerlines from the re-clustering the over segmented clusters.

Example 5: The machine-readable storage media of example 1, wherein subsampling the lidar data comprises applying voxel-based subsampling point cloud of the lidar data to generate voxel-based subsampled data.

Example 6: The machine-readable storage media of example 1, wherein filtering the noise objects comprise applying image-based filtering.

Example 7: A method to extract powerlines from lidar data, the method comprising: subsampling the lidar data to generated subsampled data; identifying ground elevation from the subsampled data; removing unwanted objects within a certain height range above the ground elevation; removing unwanted objects near the powerlines in response to the removing of the unwanted objects; and filtering noise objects around the powerlines to generate filtered candidates for the powerlines.

Example 8: The method of example 7, further comprising: grouping the filtered candidates into a set of clusters using a Euclidean distance scheme; and fitting a model to each cluster of the set of clusters to re-cluster the filtered candidates for the powerlines.

Example 9: The method of example 8, wherein fitting the model comprises: translating points for the filtered candidates for the powerlines into a local coordinate system by calculating a centroid.

Example 10: The method of example 9, further comprising: detecting individual powerlines from the filtered candidates by re-clustering over segmented clusters on same powerlines; and reconstructing powerlines from the re-clustering the over segmented clusters.

Example 11: The method of example 7, wherein subsampling the lidar data comprises applying voxel-based subsampling point cloud of the lidar data to generate voxel-based subsampled data.

Example 12: The method of example 7, wherein filtering the noise objects comprise applying image-based filtering.

Example 13: An apparatus to extract powerlines from lidar data, the apparatus comprising: a memory to store instructions; a processor circuitry to execute the instructions; and a communication interface to allow the processor circuitry to communicate with another device, wherein the processor circuitry is operable to: subsample the lidar data to generated subsampled data; identify ground elevation from the subsampled data; remove unwanted objects within a certain height range above the ground elevation; remove unwanted objects near the powerlines in response to the removing the unwanted objects; and filter noise objects around the powerlines to generate filtered candidates for the powerlines.

Example 14: The apparatus of example 13, wherein the processor circuitry is operable to: group the filtered candidates into a set of clusters using a Euclidean distance scheme; and fit a model to each cluster of the set to re-cluster the filtered candidates for the powerlines.

Example 15: The apparatus of example 14, wherein processor circuitry is to fit the model by translating points for the filtered candidates for the powerlines into a local coordinate system by calculating a centroid.

Example 16: The apparatus of example 15, wherein the processor circuitry is operable to: detect individual powerlines from the filtered candidates by re-clustering over segmented clusters on same powerlines; and reconstruct powerlines from the re-clustering the over segmented clusters.

Example 17: The apparatus of example 16, wherein the processor circuitry is operable to: subsample the lidar data by applying voxel-based subsampling point cloud of the lidar data to generate voxel-based subsampled data.

Example 18: The apparatus of example 13, wherein the processor circuitry is to filter noise objects by applying image-based filtering.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. A machine-readable storage media having machine readable instructions stored thereon that when executed cause one or more machines to perform a method to extract powerlines from lidar data, the method comprising:
subsampling the lidar data to generated subsampled data;
identifying ground elevation from the subsampled data;
removing unwanted objects within a certain height range above the ground elevation;
removing unwanted objects near the powerlines in response to the removing of the unwanted objects; and
filtering noise objects around the powerlines to generate filtered candidates for the powerlines.

2. The machine-readable storage media of claim 1, having machine readable instructions stored thereon that when executed cause one or more machines to perform a further method comprising:
grouping the filtered candidates into a set of clusters using a Euclidean distance scheme; and
fitting a model to each cluster of the set of clusters to re-cluster the filtered candidates for the powerlines.

3. The machine-readable storage media of claim 2, wherein fitting the model comprises:
translating points for the filtered candidates for the powerlines into a local coordinate system by calculating a centroid.

4. The machine-readable storage media of claim 3, having machine-readable instructions stored thereon that when executed cause one or more machines to perform a further method comprising:
detecting individual powerlines from the filtered candidates by re-clustering over segmented clusters on same powerlines; and
reconstructing powerlines from the re-clustering the over segmented clusters.

5. The machine-readable storage media of claim 1, wherein subsampling the lidar data comprises applying voxel-based subsampling point cloud of the lidar data to generate voxel-based subsampled data.

6. The machine-readable storage media of claim 1, wherein filtering the noise objects comprise applying image-based filtering.

7. A method to extract powerlines from lidar data, the method comprising:
subsampling the lidar data to generated subsampled data;
identifying ground elevation from the subsampled data;
removing unwanted objects within a certain height range above the ground elevation;
removing unwanted objects near the powerlines in response to the removing of the unwanted objects; and
filtering noise objects around the powerlines to generate filtered candidates for the powerlines.

8. The method of claim 7, further comprising:
grouping the filtered candidates into a set of clusters using a Euclidean distance scheme; and
fitting a model to each cluster of the set of clusters to re-cluster the filtered candidates for the powerlines.

9. The method of claim 8, wherein fitting the model comprises:
translating points for the filtered candidates for the powerlines into a local coordinate system by calculating a centroid.

10. The method of claim 9, further comprising:
detecting individual powerlines from the filtered candidates by re-clustering over segmented clusters on same powerlines; and
reconstructing powerlines from the re-clustering the over segmented clusters.

11. The method of claim 7, wherein subsampling the lidar data comprises applying voxel-based subsampling point cloud of the lidar data to generate voxel-based subsampled data.

12. The method of claim 7, wherein filtering the noise objects comprise applying image-based filtering.

13. An apparatus to extract powerlines from lidar data, the apparatus comprising:
a memory to store instructions;
a processor circuitry to execute the instructions; and
a communication interface to allow the processor circuitry to communicate with another device, wherein the processor circuitry is operable to:
subsample the lidar data to generated subsampled data;
identify ground elevation from the subsampled data;
remove unwanted objects within a certain height range above the ground elevation;
remove unwanted objects near the powerlines in response to the removing the unwanted objects; and
filter noise objects around the powerlines to generate filtered candidates for the powerlines.

14. The apparatus of claim 13, wherein the processor circuitry is operable to:
group the filtered candidates into a set of clusters using a Euclidean distance scheme; and
fit a model to each cluster of the set to re-cluster the filtered candidates for the powerlines.

15. The apparatus of claim 14, wherein processor circuitry is to fit the model by translating points for the filtered candidates for the powerlines into a local coordinate system by calculating a centroid.

16. The apparatus of claim 15, wherein the processor circuitry is operable to:
detect individual powerlines from the filtered candidates by re-clustering over segmented clusters on same powerlines; and
reconstruct powerlines from the re-clustering the over segmented clusters.

17. The apparatus of claim 16, wherein the processor circuitry is operable to:
subsample the lidar data by applying voxel-based subsampling point cloud of the lidar data to generate voxel-based subsampled data.

18. The apparatus of claim 13, wherein the processor circuitry is to filter noise objects by applying image-based filtering.
